(19) United States
(12) Patent Application Publication
(10) Pub. No.: US 2026/0243707 A1
(43) Pub. Date: Aug. 20, 2026

(54) SYSTEM AND METHOD FOR CAPTURING AND PROCESSING CT SCANS

(71) Applicant: Honeywell Federal Manufacturing & Technologies, LLC, Kansas City, MO (US)

(72) Inventors: Timothy Mark Force, Jr., Raymore, MO (US); Matthew Charles McKown, Olathe, KS (US)

(21) Appl. No.: 19/053,787

(22) Filed: Feb. 14, 2025

(51) Int. Cl. G01N 23/046

(52) U.S. Cl. CPC G01N 23/046; G01N 2223/304; G01N 2223/306; G01N 2223/321; G01N 2223/33; G01N 2223/401

(57) ABSTRACT

A method of capturing computed tomography (CT) data of an article includes (a) capturing, via a CT scanning device, a CT scan of the article; (b) adjusting, via an actuator, an orientation of the CT scanning device and/or a position of the CT scanning device relative to the article at a sub-pixel level relative to a resolution of the CT scanning device based upon a pattern; (c) repeating steps (a) and (b) so that multiple CT scans of the article are captured; and (d) integrating, via a processing element, the CT scans of the article to form an integrated CT scan of the article.

### FEDERALLY SPONSORED RESEARCH AND DEVELOPMENT

This invention was made with Government support under Contract No.: DE-NA0002839 awarded by the United States Department of Energy/National Nuclear Security Administration. The Government has certain rights in the invention.

### BACKGROUND OF THE INVENTION

Computed tomography (CT) scanning is an imaging technique used to create images of internal structures. It is used in industrial applications for quality control of products. For example, CT scanning may be used to detect defects, such as voids, cracks, internal structures being outside of predefined tolerances, or the like. CT scanning devices generally include a source of X-ray radiation and detectors that detect the radiation to essentially peer inside a product. CT scanning devices are often in electromagnetically noisy environments and therefore collected CT data can be adversely affected by external radiation. This can inhibit the ability to accurately detect defects in products.

Thus, there is a need for an improved method of CT scanning techniques. This background discussion is intended to provide information related to the present invention which is not necessarily prior art.

### SUMMARY OF THE INVENTION

Embodiments of the current invention address one or more of the above-mentioned problems and provide a distinct advance in the art of computed tomography (CT) scanning.

One embodiment of the invention is a method of capturing CT data of an article includes (a) capturing, via a CT scanning device, a CT scan of the article; (b) adjusting, via an actuator, an orientation of the CT scanning device and/or a position of the CT scanning device relative to the article at a sub-pixel level relative to a resolution of the CT scanning device based upon a pattern; (c) repeating steps (a) and (b) so that multiple CT scans of the article are captured; and (d) integrating, via a processing element, the CT scans of the article to form an integrated CT scan of the article.

Another embodiment of the invention is a system for capturing computed tomography (CT) data of an article. The system includes a mount, an actuator, and a processing element. The mount is configured to support a CT scanning device. The actuator is configured to adjust an orientation of the mount and/or a position of the mount relative to the article. The processing element is in communication with the actuator and is configured to send a control signal to the CT scanning device representative of an instruction to capture a first CT scan of the article, send to the actuator a control signal representative of an instruction to adjust the orientation of the mount and/or a position of the mount relative to the article at a sub-pixel level relative to a resolution of the CT scanning device, send a control signal to the CT scanning device representative of an instruction to capture a second CT scan of the article, and integrate the first CT scan with the second CT scan to form an integrated CT scan of the article.

Another embodiment of the invention is a non-transitory computer readable media having instructions stored thereon, that when executed by a processor, cause the processor to (a) transmit a signal representative of an instruction to capture, via a CT scanning device, a CT scan of an article; (b) transmit a signal representative of an instruction to adjust, via an actuator, an orientation of the CT scanning device and/or a position of the CT scanning device relative to the article at a sub-pixel level relative to a resolution of the CT scanning device based upon a pattern; (c) repeat steps (a) and (b) so that multiple CT scans of the article are captured; and (d) integrate the multiple CT scans to form an integrated CT scan of the article.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a block diagram depicting selected components of an exemplary environment in which embodiments of the present invention may be implemented; and

FIG. 2 is a flowchart depicting exemplary steps of a method according to an embodiment of the present invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

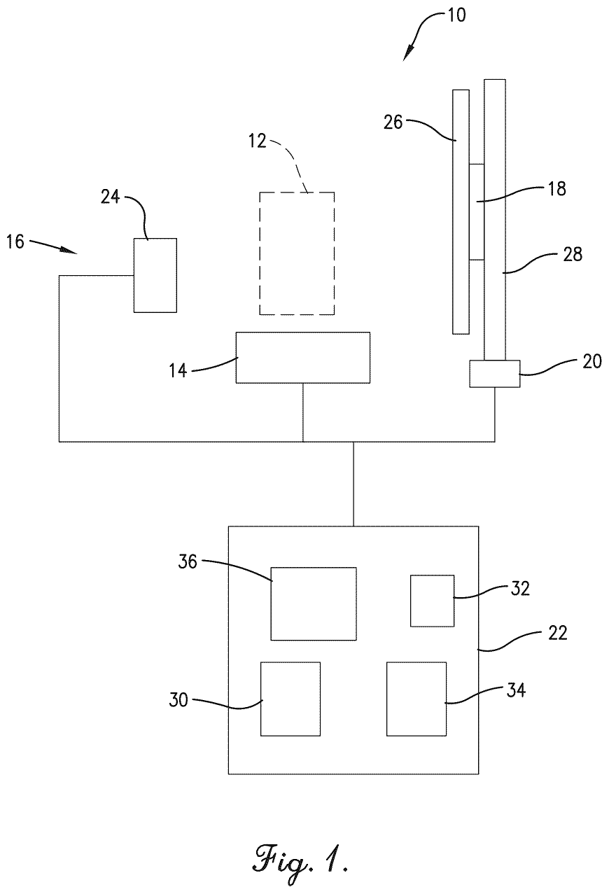

Turning to FIG. 1, a system 10 for capturing computed tomography (CT) data of an object 12 according to embodiments of the present invention is depicted. The object 12 may be an article or end product. However, it is foreseen that other types of objects 12 may be scanned using embodiments of the present invention without departing from the scope of the present invention, including human, animal, or other biological subjects, soil samples, rock samples, or the like. The system 10 broadly comprises a platform 14 for supporting the object 12, one or more CT scanning devices 16, one or more mounts 18 for supporting at least a portion of the CT scanning device 16, one or more actuators 20, and a controller 22.

The platform 14 is operable to support the object 12 during scanning. In one or more embodiments, the platform 14 may be configured to shift relative to at least a portion of the CT scanning device 16 via one or more actuators (not shown) for adjusting the relative position and/or orientation of the object 12 relative to at least a portion of the CT scanning device 16.

The CT scanning device 16 is configured to capture CT scans of the object 12. In one or more embodiments, the CT scanning device 16 includes a radiation source 24 and a sensor 26. The radiation source 24 may be configured to generate X-ray radiation toward the object 12, and the sensor 26 is configured to detect the X-ray radiation for generating a CT scan of the object 12. The sensor 26 may be a flat panel detector. The CT scanning device 16 may be any CT scanning device known in the art without departing from the scope of the present invention, including the CT scanning devices described and depicted in U.S. Patent Application Publication Nos. 2023/0148975 and 2024/0386628, which are hereby incorporated by reference herein.

The mount 18 is configured to support a portion of the CT scanning device 16. In one or more embodiments, the mount 18 is configured to support the scanning device sensor 26. The mount 18 may be shiftable relative to the object 12. For example, the mount 18 may be configured to shift so that its orientation is adjusted relative to the object 12. Additionally or alternatively, the mount 18 may be configured to shift along a vertical axis relative to the object 12, such as along a track 28. The mount 18 may be configured to shift any number of ways without departing from the scope of the present invention.

The actuator 20 is configured to adjust at least one of a relative orientation between the mount 18 and the object 12 and/or a relative position between the mount 18 and the object 12. The actuator 20 may be any type of actuator 20 known in the art, including a linear actuator, a motor, hydraulic or pneumatic actuator, or the like. Additionally or alternatively, the system 10 may include one or more actuators configured to adjust a relative position/orientation of the platform 14 holding the object 12 and/or the radiation source 24.

The controller 22 is configured to control operations of the system 10. The controller 22 is configured to implement one or more dithering techniques when capturing one or more CT scans for filtering out noise caused by the CT scanning device 16 and/or from other sources. The dithering technique may be any technique known in the art that causes sub-pixel shifts in relative position and/or orientation between the CT scanning device 16 and the object 12 between two or more scans. As used herein, “sub-pixel” refers to a shift or distance corresponding to a non-integer number of pixels with respect to the resolution of the CT scanning device, including a fraction less than 1, or a non-integer number greater than 1. For example, the object 12 may be shifted (translated, rotated, etc.) so that a reference point on the object 12 shifts a non-integer number of pixels relative to the scanning device 16. The controller 22 may be configured to control the actuator 20 for executing the dithering technique. In one or more embodiments, the controller 22 is further configured to perform one or more image processing techniques to the captured CT scans, including performing drizzle image processes. The drizzle image processes may include one or more variable-pixel linear reconstruction algorithms. The controller 22 may be configured to perform any number of image processing algorithms without departing from the scope of the present invention. In one or more embodiments, the controller 22 comprises one or more communication elements 30, one or more memory elements 32, a user interface 34, and one or more processing elements 36. The communication element 30 generally allows communication between the controller 22 and external components, such as the CT scanning device 16 and the actuator 20. The user interface 34 is configured to receive inputs from a user and display data, such as CT scans on a display.

The memory element 32 is configured to store one or more patterns, such as a pattern for implementing dithering techniques, for shifting the object 12 relative to the CT scanning device 16. The one or more patterns may include a set of movements, and/or an algorithm for determining movements, of the CT scanning device 16 relative to the object 12 (or vice versa). The patterns may be regular patterns of movement or pseudorandom patterns of movement.

The processing element 36 is configured to send one or more control signals to the CT scanning device 16 representative of an instruction to capture one or more first CT scans of the object 12. The processing element 36 may be configured to orient the object 12 and the CT scanning device 16, such as the sensor 26, at a first relative orientation and/or position, by sending one or more control signals to the actuator 20. The CT scanning device 16 may then capture a first CT scan of the object 12 at the first relative position/orientation between the object 12 and the CT scanning device 16, such as the relative position/orientation between the sensor 26 and the object 12.

The processing element 36 may further be configured to adjust the relative position/orientation of the object 12 relative to the CT scanning device 16 for implementing one or more dithering techniques. For example, the processing element 36 may be configured to retrieve the desired dithering pattern from the memory element 32, determine a movement of one or more components of the system 10 to achieve a second relative orientation and/or position between the object 12 and the CT scanning device 16 based on the pattern, and send to the actuator 20 one or more control signals representative of an instruction to implement the movement to adjust the relative orientation and/or position of the object 12 and the CT scanning device 16 to the second orientation/position. In one or more embodiments, the processing element is configured to send a control signal to the actuator 20 to shift the mount 18 and therefore the sensor 26 relative to the object 12, thereby adjusting the orientation of the mount 18 and sensor 26 and/or a position of the mount 18 and sensor 26 relative to the object 12. In one or more embodiments, the movement is at a sub-pixel level relative to a resolution of the CT scanning device 16. For example, if the CT scanning device 16 has a resolution of 100 micrometers, then the movement may be less than 100 micrometers or a non-integer multiple of 100 micrometers.

In one or more embodiments, the processing element 36 is configured to send one or more control signals to the CT scanning device 16 representative of an instruction to capture one or more additional CT scans of the object 12. The processing elements 36 may be configured to repeatedly adjust the position/orientation between the object 12 and the CT scanning device 16 according to the desired dithering pattern and capture corresponding CT scans a sufficient number of times at different orientations and/or positions to obtain a signal-to-noise ratio below a desired threshold when the CT scans are integrated. In one or more embodiments, the processing element 36 is configured to instruct the actuator 20 to shift the object 12, and instruct the CT scanning device 16 to capture multiple scans while the object 12 is shifting. The processing element 36 may be configured to instruct the CT scanning device 16 so that the timing of the CT scans are taken at sub-pixel shifts of the object 12.

In one or more embodiments, the processing element 36 is configured to perform one or more drizzle image processing techniques for integrating the multiple CT scans to form one or more integrated CT scans of the object 12. The processing element 36 may be configured to integrate the one or more CT scans of the object 12 using one or more variable-pixel linear reconstruction algorithms or the like. By using drizzle image processes, the processing element 36 is configured to use the image data captured with the dithering technique to compute additional pixels in the integrated CT scan, thereby increasing the resolution of the image. This enables increasing the effective resolution of the CT scanning device 16 through computation, which is significantly cheaper than increasing the resolution through the addition of pixels/sensors in the CT scanning device 16.

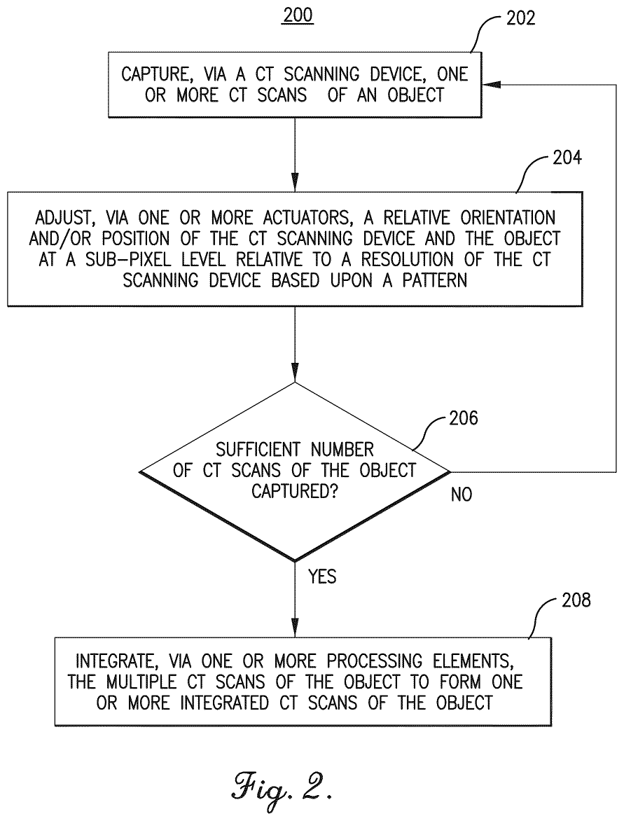

The flow chart of FIG. 2 depicts the steps of an exemplary method 200 of capturing CT data of an object. In some alternative implementations, the functions noted in the various blocks may occur out of the order depicted in FIG. 2. For example, two blocks shown in succession in FIG. 2 may in fact be executed substantially concurrently, or the blocks may sometimes be executed in the reverse order depending upon the functionality involved. In addition, some steps may be optional.

The method 200 is described below, for ease of reference, as being executed by exemplary devices and components introduced with the embodiment illustrated in FIG. 1. The steps of the method 200 may be performed by the controller through the utilization of processors, transceivers, hardware, software, firmware, or combinations thereof. However, some of such actions may be distributed differently among such devices or other devices without departing from the spirit of the present invention. Control of the system may also be partially implemented with computer programs stored on one or more non-transient computer-readable medium(s). The computer-readable medium(s) may include one or more executable programs stored thereon, wherein the program(s) instruct one or more processing elements to perform all or certain of the steps outlined herein. The program(s) stored on the computer-readable medium(s) may instruct processing element(s) to perform additional, fewer, or alternative actions, including those discussed elsewhere herein.

Referring to step 202, one or more CT scans of the object are captured via one or more CT scanning devices. The CT scans may be captured using a dithering technique. For example, the CT scans may be captured while the object and the CT scanning device are at first relative positions and/or orientations relative to one another according to a pattern, such as a regular or pseudorandom pattern. This step may include transmitting, via the controller, one or more control signals representative of an instruction to capture the one or more CT scans of the object and capturing, via the CT scanning device, the one or more CT scans of the object based at least in part on the one or more control signals from the controller.

Referring to step 204, the relative orientation between the CT scanning device and the object and/or the relative position between the CT scanning device relative and the object is adjusted, via one or more actuators, at a sub-pixel level relative to a resolution of the CT scanning device based upon the dithering pattern. This step may include transmitting, via the controller, one or more control signals representative of the pattern stored on the memory element and adjusting, via the actuator, the orientation of the CT scanning device and/or the position of the CT scanning device based on the one or more control signals. The scans may be taken after the relative orientation between the CT scanning device and the object and/or relative position between the CT scanning device and the object is adjusted and/or while the adjustments are made. For example, the relative positions/orientations may be shifted in accordance with a pattern, and the CT scans may be taken while the movement is occurring.

Referring to step 206, the controller determines if a sufficient number of CT scans of the object have been captured. The sufficient number may be a preset number based upon a signal-to-noise ratio being below a desired threshold. If there is an insufficient number of CT scans, then steps 202 and 204 are repeated so that multiple images are captured using the dithering technique. The steps 202 and 204 may be repeated any number of times so that any number of CT scans are captured without departing from the scope of the present invention. In one or more embodiments, the steps 202 and 204 are repeated until the one or more integrated CT scans has a signal-to-noise ratio below a desired threshold.

Referring to step 208, the multiple CT scans of the object are integrated, via the controller, to form one or more integrated CT scans of the article. As discussed elsewhere herein, this step may include performing, via the controller, one or more drizzle image processing techniques, such as variable-pixel linear reconstruction algorithms, to form the one or more integrated CT scans of the article

The method 200 may include additional, less, or alternate steps and/or device(s), including those discussed elsewhere herein.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

The processing element may include processors, microprocessors (single-core and multi-core), microcontrollers, DSPs, field-programmable gate arrays (FPGAs), analog and/or digital application-specific integrated circuits (ASICs), or the like, or combinations thereof. The processing element may generally execute, process, or run instructions, code, code segments, software, firmware, programs, applications, apps, processes, services, daemons, or the like. The processing element may also include hardware components such as finite-state machines, sequential and combinational logic, and other electronic circuits that can perform the functions necessary for the operation of the current invention. The processing element may be in communication with the other electronic components through serial or parallel links that include address busses, data busses, control lines, and the like.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The memory device or element may include data storage components, such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element may be embedded in, or packaged in the same package as, the processing element. The memory element may include, or may constitute, a “computer-readable medium”. The memory element may store the instructions, code, code segments, software, firmware, programs, applications, apps, services, daemons, or the like that are executed by the processing element.

The communication element may generally allow communication with systems and/or external devices. The communication element may include signal or data transmitting and receiving circuits, such as antennas, amplifiers, filters, mixers, oscillators, digital signal processors (DSPs), and the like. The communication element may establish communication wirelessly by utilizing RF signals and/or data that comply with communication standards such as cellular 2G, 3G, 4G, 5G, or LTE, WiFi, WiMAX, Bluetooth®, BLE, or combinations thereof. The communication element may be in communication with the processing element and the memory element.

The user interface generally allows the user to utilize inputs and outputs to interact with the device and is in communication with the one or more processing element. Inputs may include buttons, pushbuttons, knobs, jog dials, shuttle dials, directional pads, multidirectional buttons, switches, keypads, keyboards, mice, joysticks, microphones, or the like, or combinations thereof. The outputs of the present invention may include a display and/or any number of additional outputs, such as audio speakers, lights, dials, meters, printers, or the like, or combinations thereof, without departing from the scope of the present invention.

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A method of capturing computed tomography (CT) data of an article, the method comprising:
(a) capturing, via a CT scanning device, one or more CT scans of the article;
(b) adjusting, via one or more actuators, at least one of an orientation of the CT scanning device or a position of the CT scanning device relative to the article at a non-multiple of the pixel pitch of the CT scanning device based upon a pattern;
(c) repeating steps (a) and (b) so that multiple CT scans of the article are captured; and
(d) integrating, via one or more processing elements, the multiple CT scans of the article to form one or more integrated CT scans of the article.

2. The method of claim 1, wherein the pattern is a pseudorandom pattern.

3. The method of claim 1, wherein the pattern is a regular pattern.

4. The method of claim 1, wherein step (c) includes repeating steps (a) and (b) so that the one or more integrated CT scans has a signal-to-noise ratio below a desired threshold.

5. The method of claim 1, wherein step (d) comprises performing, via the one or more processing elements, one or more variable-pixel linear reconstruction algorithms to form the one or more integrated CT scans of the article.

6. The method of claim 1, wherein step (b) comprises:
transmitting, via the one or more processing elements, one or more control signals representative of the pattern stored on one or more memory elements in communication with the one or more processing elements; and
adjusting, via the one or more actuators, at least one of the orientation of the CT scanning device or the position of the CT scanning device based at least in part on the one or more control signals.

7. The method of claim 1, wherein step (a) comprises:
transmitting, via the one or more processing elements, one or more control signals representative of an instruction to capture the one or more CT scans of the article; and
capturing, via the CT scanning device, the one or more CT scans of the article based at least in part on the one or more control signals.

8. A system for capturing computed tomography (CT) data of an article, the system comprising:
a mount configured to support at least a portion of a CT scanning device;
one or more actuators configured to adjust at least one of an orientation of the mount or a position of the mount relative to the article; and
one or more processing elements in communication with the one or more actuators and configured to:
send one or more control signals to the CT scanning device representative of an instruction to capture one or more first CT scans of the article,
send to the one or more actuators one or more control signals representative of an instruction to adjust at least one of the orientation of the mount or a position of the mount relative to the article at a sub-pixel level relative to a resolution of the CT scanning device,
send one or more control signals to the CT scanning device representative of an instruction to capture one or more second CT scans of the article, and
integrate the one or more first CT scans of the article with the one or more second CT scans of the article to form one or more integrated CT scans of the article.

9. The system of claim 8, wherein the one or more control signals sent to the one or more actuators are based on a regular pattern of movement.

10. The system of claim 8, wherein the one or more control signals sent to the one or more actuators are based on a pseudorandom pattern of movement.

11. The system of claim 10, further comprising one or more memory elements configured to store the pseudorandom pattern.

12. The system of claim 8, wherein the one or more processing elements is configured to direct the one or more actuators to adjust the mount and direct the CT scanning device to capture a sufficient number of CT scans at different orientations or positions so that the one or more integrated CT scans has a signal-to-noise ratio below a desired threshold.

13. The system of claim 8, wherein the one or more processing elements is configured to integrate the one or more first CT scans of the article using one or more variable-pixel linear reconstruction algorithms.

14. The system of claim 8, wherein the CT scanning device includes one or more CT scanning sensors coupled to the mount and in communication with the one or more processing elements.

15. Non-transitory computer readable media having instructions stored thereon, that when executed by at least one processor, cause the at least one processor to:
(a) transmit one or more signals representative of an instruction to capture, via one or more CT scanning device, one or more CT scans of an article;
(b) transmit one or more signals representative of an instruction to adjust, via one or more actuators, at least one of an orientation of the one or more CT scanning devices or a position of the one or more CT scanning devices relative to the article at a sub-pixel level relative to a resolution of the one or more CT scanning devices based upon a pattern;
(c) repeat steps (a) and (b) so that multiple CT scans of the article are captured; and
(d) integrate the multiple CT scans of the article to form one or more integrated CT scans of the article.

16. The non-transitory computer readable media of claim 15, wherein the pattern is a pseudorandom pattern.

17. The non-transitory computer readable media of claim 15, wherein the pattern is a regular pattern.

18. The non-transitory computer readable media of claim 15, wherein the instructions, when executed by the at least one processor, cause the at least one processor to repeat steps (a) and (b) so that the one or more integrated CT scans has a signal-to-noise ratio below a desired threshold.

19. The non-transitory computer readable media of claim 15, wherein step (d) comprises executing one or more variable-pixel linear reconstruction algorithms to form the one or more integrated CT scans of the article.

20. The non-transitory computer readable media of claim 15, wherein the instructions, when executed by the at least one processor, cause the at least one processor to retrieve from one or more memory elements a value derived from the pattern.
